(19) United States
(12) Patent Application Publication
(10) Pub. No.: US 2008/0172495 A1
(43) Pub. Date: Jul. 17, 2008

(54) Cookieless Tracking System

(76) Inventor: Timothy C. Storm, Rockton, IL (US)

Correspondence Address: REINHART BOERNER VAN DEUREN P.C., 2215 PERRYGREEN WAY, ROCKFORD, IL, 61107, US

(21) Appl. No.: 12/015,152

(22) Filed: Jan. 16, 2008

Related U.S. Application Data
(60) Provisional application No. 60/885,120, filed on Jan. 16, 2007.

(51) Int. Cl. G06F 15/16

(52) U.S. Cl. 709/245

(57) ABSTRACT

A method of tracking during an affiliate referral transaction without relying on cookies is provided. The method includes requesting a unique session identifier from a merchandiser. A hyperlink is then published on a website of an affiliate. Next, the unique session identifier is added to a sub-domain portion of a domain name of a merchandiser when the hyperlink is activated by a customer. The unique session identifier and the customer are passed to the merchandiser. The merchandiser uses the unique session identifier to track either or both the affiliate and the customer. Thereafter, information is transmitted between the affiliate and the merchandiser. Then, compensation from the merchandiser is received for referral of the customer to the merchandiser.

### CROSS-REFERENCE TO RELATED PATENT APPLICATIONS

This patent application claims the benefit of U.S. Provisional Patent Application No. 60/885,120, filed Jan. 16, 2007, the teaching and disclosure of which are hereby incorporated in their entireties by reference thereto.

### FIELD OF THE INVENTION

This invention generally relates to electronic commerce methods and, more particularly, to the transmission or exchange of information between electronic commerce merchandisers, their affiliates, and in some cases specific third parties.

### BACKGROUND OF THE INVENTION

Merchandisers often operate electronic commerce (or e-commerce) websites using the World Wide Web (WWW) on the Internet to sell goods and services. Therefore, potential and actual customers (hereinafter collectively, “customers”) are able to more easily find and purchase the goods and services using, for example, an Internet-enabled computer having a web browser.

Those merchandisers having e-commerce websites are continually attempting to increase the number of customers visiting their website. To that end, the merchandisers often spend a great deal of time and money advertising. However, as many merchandisers have discovered, trying to effectively advertise using conventional methods such as, for example, through television, newspaper, and Internet advertisements, is very expensive and not particularly effective.

As an alternative or supplement to advertising, many merchandisers have set up affiliate or associate (hereinafter collectively, “affiliate”) programs. Under these affiliate programs, affiliates who register with the merchandiser are compensated by the merchandiser for directing or referring customers to the merchandiser's website. In the end, these affiliate programs are often less costly for the merchandiser to implement and administer compared to the expense of traditional advertising. In addition, these affiliate programs often lead to substantially increased sales of goods and services for the merchandiser.

For example, in one typical method 10 as shown in simplified schematic form in the prior art illustration of FIG. 1, when a potential or existing customer using a web browser on an Internet-enabled computer 12 visits the website and/or views the web pages of the affiliate, the affiliate's web server 14 places a “cookie” 16 (a.k.a., Hypertext Transfer Protocol (HTTP) cookie or Web cookie) on the customer's computer through the web browser. Each time the customer revisits the affiliate's website, the cookie 16 is sent from the user's computer back to the affiliate's web server unchanged. Through this cookie transfer and exchange protocol, the cookie 16 is used by the affiliate for the purpose of authenticating, tracking, and maintaining information about the customer. Such information includes, but is not limited to, the customer's site preferences, contents of the customer's shopping cart, the customer's purchase history, and the like.

Continuing the above example, when the affiliate intends to refer the customer to the merchandiser, the affiliate first contacts an affiliate marketer. The affiliate marketer server 18 places a second cookie 20 on the computer 12 of the customer. This second cookie 20 functions much like the cookie 16 but includes customer specific information for the benefit of the affiliate marketer. Thereafter, the affiliate marketer establishes a relationship between the affiliate and the merchandiser. With the relationship in place, the affiliate then transfers information about the customer to the merchandiser server 22. Armed with that information, the merchandiser continues to service the client and present them with merchandise. In doing so, the merchandiser's server 22 usually also places a cookie 24 on the customer's computer 12 for their own benefit.

Unfortunately, the use of cookies has drawbacks. For example, because cookies are used for tracking browsing behavior, they have recently been of great concern to Internet privacy advocates. As a result, cookies have been subject to legislation in various countries such as the United States and in various regions such as the European Union.

In addition, cookies are also subject to a number of misconceptions, mostly based on the erroneous notion that they are computer programs. Even though cookies are simple pieces of data unable to perform any operation by themselves, they are often associated with malicious and undesirable code such as spyware, adware, viruses, and the like. As a result, cookies are frequently detected and removed, sometimes inadvertantly, from computers by products designed to rid the computer of any perceived malicious or undesirable code.

Also, most modern browsers permit users to decide for themselves whether to accept cookies. Based on the erroneous belief that cookies are dangerous and therefore unwanted, customers sometimes manipulate their browser's settings to reject most or all cookies. By configuring their computer's settings in this manner, numerous websites become unusable. For example, shopping baskets implemented using cookies do not work if cookies are rejected.

As a further drawback, when the affiliate refers the customer to the merchandiser, the cookies used as noted above are unable to provide the merchant with good tracking information that uniquely identifies the affiliate as the source of the referral. As a result, once the affiliate passes the customer over to the merchandiser, the affiliate is generally at the mercy of the merchandiser's tracking and/or accounting system. If the merchandiser's systems are poor or unreliable, the affiliate may not get compensated for the referral as expected.

There exists, therefore, a need in the art for a cookieless tracking system that operates without having to place cookies on a customer computer and permits merchandisers to better track a particular affiliate as the source of a referral. The invention provides such a cookieless tracking system. These and other advantages of the invention, as well as additional inventive features, will be apparent from the description of the invention provided herein.

### BRIEF SUMMARY OF THE INVENTION

The invention provides a method of using a sub-domain portion of a domain name to eliminate the need to place a cookie on a customer's computer and to permit a merchandiser to more easily track a particular affiliate as a source of referral.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic illustrating one example of a prior art transaction where cookies are placed on a customer's computer when the customer has been referred to a merchandiser through an affiliate.

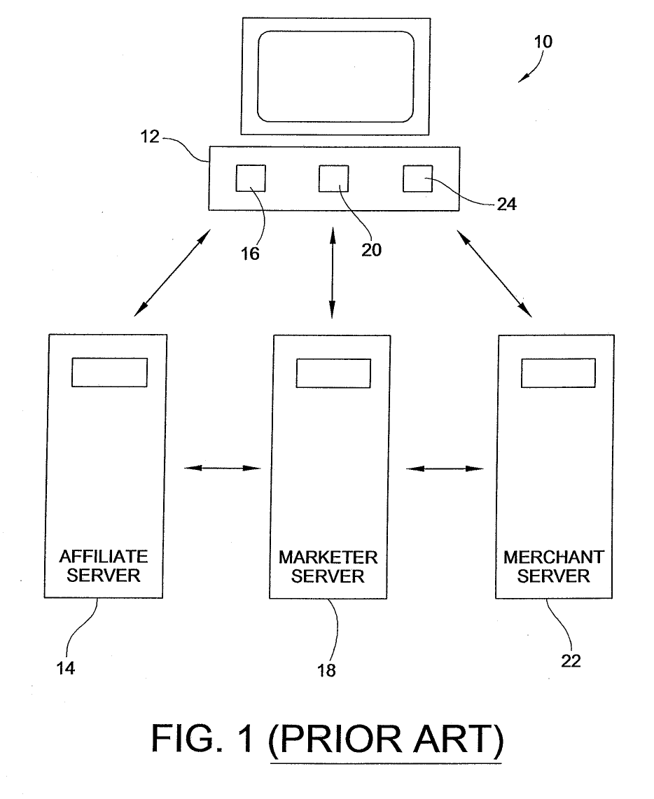

FIG. 2 is an exemplary embodiment of a method of performing an affiliate transaction such that cookies are not needed and the merchandiser is able to track the affiliate as the source of referral in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

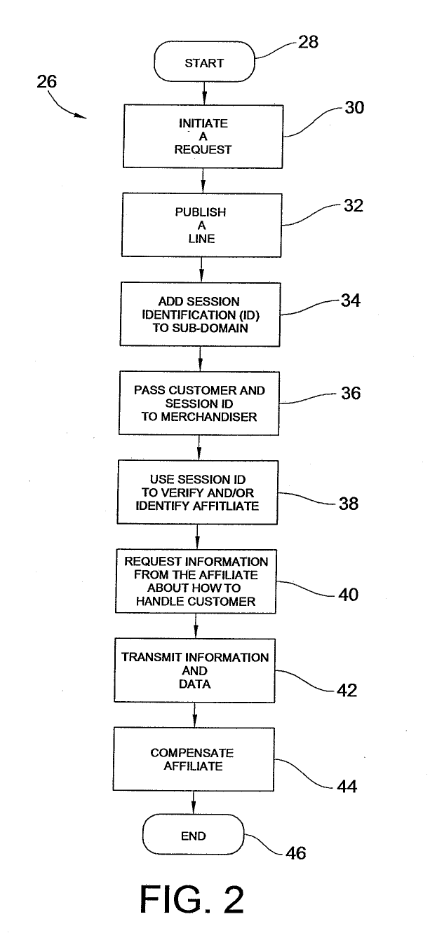

Referring to FIG. 2, a method 26 of performing an affiliate transaction such that cookies are not needed and the merchandiser is able to track the affiliate as the source of referral. As will be more fully explained below, the method 26 generally uses a sub-domain portion of a domain name to pass a unique identifier to a merchandiser. The method 26 eliminates the need to place cookies on a customer computer and permits merchandisers to better track a particular affiliate as the source of a referral.

The method begins or starts 28 when the affiliate initiates 30 a request for a unique session identifier from the merchandiser. Once the unique session identifier has been obtained, the affiliate publishes 32 one or more of their own hyperlinks (a.k.a., links) on their web site, in an electronic mail (e-mail) message, and the like. These links may appear as, for example, http://www.affiliate.com/mechandiser, http://www.affiliate.com/mechandiseroffer, and the like. After publication, the link is accessible and visible to the customer.

While a user is browsing an affiliate's website (at, for example, www.affiliate.com) using a web browser (e.g., Internet Explorer) or other specialty software on an networked machine (e.g., an Internet-enabled personal computer (PC), a wireless handheld device, a cell phone, etc.), the user may find that particular goods and/or services offered by a merchandiser are appealing. Therefore, the user decides to visit the website of the merchandiser who is offering the desired goods or services. To do so, the user activates the link to the merchandiser's website (e.g., at http://www.affiliate.com/mechandiser) or the link to the offer from the merchandiser (e.g., at http://www.affiliate.com/mechandiseroffer) which is conveniently located and found on the affiliate's website, in the e-mail message, and the like.

The user is able to activate the link by, for example, moving a cursor over the link with an input device (e.g., a mouse, a keyboard, etc.) operably coupled to the PC and actuating the input device (e.g., by depressing one of the buttons found on the mouse). This process is often referred to as “clicking” on the link. As well known to those skilled in the art, the link may appear on the affiliate's website as a word or phrase, an underlined word or phrase, an image or as some other object.

After the link has been activated by the user, a common redirection system on the affiliate website adds 34 the unique session identifier to a sub-domain portion of the merchandiser's domain name. For example, the affiliate's website generates the following URL string: http://www.uniquesessionindentifier.merchandiser.com/. Thereafter, the common redirection link system on the affiliate's website passes 36 the customer and the unique session identifier to the merchandiser's website or to an intermediary website (e.g., a secure shopping service website).

The intermediary website is often operated by an independent third party but, in one embodiment, is operated by a party related to the operator of the destination website such as, for example, a subsidiary company. For example, some e-commerce merchandisers (e.g., eBay) offer their own payment services (e.g., PayPal) to those who purchase from their website.

When the unique session identifier and customer have arrived at the merchandiser's website, the merchandiser uses 38 the unique session identifier conveyed in the sub-domain portion of the domain name to, for example, identify the affiliate and/or verify that the affiliate is registered with the established affiliate program and, as such, authorized by the merchandiser to provide referrals (hereinafter, collectively “the identification process”). Because the unique session identifier was previously provided to a particular affiliate, the merchandiser is able to quickly and easily correlate the session identifier with the affiliate that just provided the referral.

In addition to the above, after the identification process is completed the merchandiser generally requests 40 information from the affiliate about how to handle and/or what to do with the customer that was just referred. Alternatively or in addition, the merchandiser pre-associates the unique identifier with a selected action such as, for example, open a shopping cart with a particular item therein. Thereafter, the customer continues to shop and browser products on the merchandiser's website as normal.

Advantageously, because the unique session identifier remains within the URL string during all or a good portion of the customer's shopping experience, the identity of the affiliate who referred the customer to the merchandiser is not lost or misplaced. Moreover, during this shopping transaction, no cookies need to be planted on the user's computer by the affiliate, the intermediary, or the merchandiser. The customer and/or the referring affiliate are identified through the unique session identifier.

In addition to using the sub-domain portion of the domain name, in one embodiment further sub-domains of the sub-domain (i.e., a sub-sub-domain) are used. Basically, any portion of the URL string to the left of the domain name can be used as a sub-domain.

In one embodiment, during the identification process, the merchandiser accesses look-up tables. These look-up tables contain, among other things, the unique identifier codes for the plurality of affiliates who are registered and/or authorized to participate in the affiliate program. Therefore, the unique identifier that is received is quickly and easily connected to the correct affiliate.

Once the identification process and the particulars of how to handle the referred customer are completed using the unique identifier, the affiliate and the merchandiser are now able to safely and securely exchange or transmit 42, server-to-server, a variety of information and data. In one embodiment, the exchange or transmission of information and data is performed on either or both of a real-time and ad hoc basis.

The information and data transmitted or exchanged includes, for example, the domain name of the destination site, the domain name of the affiliate or referral site, the name and address of the user (i.e., the customer), the shopping history of the user, the search string or terms entered into the browser by the user to find the goods or services on the affiliate's website, the search engine used, the browser used, the placement and location of the advertisement clicked on by the user, the competitor's websites visited, any comparison shopping performed by the user, the method of payment used or preferred by the customer (e.g., by credit card, using an account established through a third party intermediary, etc.), any coupons or codes used by the customer, the contents of the shopping cart, and the like.

In one embodiment, the information and data specifically includes, but is not limited to, the affiliate partner identifier or full information, the destination merchant address, the products to automatically add to a shopping cart, the notification method for successful redirection confirmation, the notifications methods related to the shopping cart and shopping cart status, the notification for an abandoned session or lost referral chain, the notification methods related to orders, the notification method for product return and shipping status, and the notification method for commission reporting. The data and information also include the link location from the referrer site, the link type from the referrer site, discount code and coupon information, and the like.

After the identification process is completed, the merchandiser is able to compensate 44 the appropriate affiliate for the referral using the unique session identifier. Because the unique session identifier is used, the chance of paying the wrong affiliate or not accounting to the affiliate at all for the referral is reduced or kept low. As noted above, the merchandiser is able to use the unique session identifier to correlate the purchase by the customer with the referral by the affiliate through the unique session identifier. Also, because the identification process occurs very rapidly, the user is unaware that the affiliate's and merchandiser's websites have been performing these functions. To the user, the jump from the affiliate's website to that of the merchandiser is very quick and, at times, almost instantaneous.

In addition to the above, once the identification process has been completed, the server-to-server exchange of information is able to freely continue throughout a shopping session and even beyond checkout to easily handle post transaction changes, returns, cancellations, modifications, shipment notifications, status notifications, and the like.

In one embodiment, if permitted by the customer and regulations permit, the affiliate web server is able to plant a cookie on the user's computer in the event that the session is somehow lost or interrupted. For example, if the user inadvertently browses directly to the merchandiser's website, the cookie will allow the affiliate and the customer to re-associate such that the customer will enjoy the benefits that the affiliate provides. Therefore, where acceptable to do so, the cookieless tracking system and cookies may be used cooperatively and simultaneously.

In one embodiment, the use of the unique session identifier occurs through an affiliate marketer (e.g., Linkshare) acting as an intermediary between the affiliate and the merchandiser. The unique session identifier is again employed, however, this time it is used so that the affiliate marketer is able to identify the affiliate making the referral and relay that referral information to the merchandiser.

Also, in one embodiment, after receiving the unique session identifier, the merchandiser changes the session identifier that was received from the affiliate to a second unique session identifier when interacting with the customer. When doing so, the merchandiser stores both unique session identifier and the second unique session identifier in a manner permitting them to be correlated to one another. For example, both are stored in a table that associates the first unique session identifier with the second. That way, the merchandiser is able to use their own existing system of assigning session identifiers yet maintain the ability to positively identify the affiliate that provided the referral.

While other steps may be incorporated into the method, and the steps may be rearranged, once the affiliate has been compensated and the user routed to the website of the merchandiser, the method is completed or ends 46.

From the foregoing, those skilled in the art will recognize that the method 26 improves the exchange and transmission of information between affiliates and merchandisers who operate in the e-commerce environment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of tracking during an affiliate referral transaction without relying on cookies, comprising the steps of:
requesting a unique session identifier from a merchandiser;
publishing a hyperlink;
adding the unique session identifier to a sub-domain portion of a domain name of the merchandiser when the hyperlink is activated by a customer;
passing the unique session identifier and the customer to the merchandiser thereby permitting the merchandiser to use the unique session identifier to at least one of track the affiliate and the customer;
transmitting information between the affiliate and the merchandiser; and
receiving compensation from the merchandiser for referral of the customer to the merchandiser.

2. The method of claim 1, further comprising the step of being identified by the merchandiser as the affiliate referring the customer using the unique session identifier.

3. The method of claim 1, wherein the method further comprises the step of securely transmitting data with the merchandiser on a real-time, server-to-server basis.

4. The method of claim 1, wherein the step of publishing a hyperlink includes publishing the hyperlink on a website of an affiliate and wherein the hyperlink is an image or an object.

5. The method of claim 1, wherein the step of publishing a hyperlink includes publishing the hyperlink in an electronic mail message.

6. The method of claim 1, wherein the step of publishing a hyperlink renders the hyperlink accessible and visible to the customer, and wherein the method further comprises the step of receiving a request from the merchandiser on how to handle the customer.

7. The method of claim 1, wherein the step of passing the unique session identifier and the customer to the merchandiser occurs through an intermediary website.

8. The method of claim 1, wherein the step of adding the unique session identifier to a sub-domain portion of a domain name of the merchandiser when the hyperlink is activated by a customer is performed by a redirection system.

9. The method of claim 8, wherein the common redirection system generates a uniform resource locator string generally in the a format of http://www.uniquesessionindentifier.merchandiser.com.

10. A method of eliminating cookies from an affiliate referral transaction between an affiliate and a merchandiser, comprising the steps of:
requesting a unique session identifier from a merchandiser;
publishing a hyperlink on a website of an affiliate;
adding the unique session identifier to a sub-domain portion of a domain name of a merchandiser when the hyperlink is activated by a customer using a common redirection system; and
redirecting the customer, along with the unique session identifier, to the merchandiser, the merchandiser using the unique session identifier to at least one of identify the affiliate, track the affiliate, and track the customer.

11. The method of claim 10, further comprising the step of transmitting information related to the customer between the affiliate and the merchandiser.

12. The method of claim 10, further comprising the step of receiving compensation from the merchandiser for referral of the customer to the merchandiser.

13. The method of claim 10, wherein the method of redirecting the customer, along with the unique session identifier, to the merchandiser includes the merchandiser using the unique session identifier to identify the affiliate, track the affiliate, and track the customer.

14. The method of claim 10, wherein the step of publishing a hyperlink is repeated such that a plurality of the hyperlinks are published.

15. The method of claim 14, wherein a selected one of the plurality of hyperlinks is published in an electronic mail message.

16. The method of claim 10, wherein the method further comprises the step of participating in a verification process that acknowledges registration by the affiliate with an affiliate program of the merchandiser.

17. The method of claim 10, wherein the method further comprises the step of passing the customer and the unique session identifier to a merchandiser's website or to an intermediary website.

18. The method of claim 10, wherein the method further comprises the step of receiving a request for information regarding how to handle the customer that was referred by the affiliate.

19. The method of claim 10, wherein the method further comprises the step of being identified through use of look up tables of the merchandiser.

20. The method of claim 12, wherein the method further comprises the step of using the unique session identifier for post checkout transactions, the step of converting the unique session identifier to a second unique session identifier when interacting with the customer.
